(19) United States
(12) Patent Application Publication
(10) Pub. No.: US 2002/0035530 A1
(43) Pub. Date: Mar. 21, 2002

(54) COMPUTER SYSTEM AND PROCESS FOR A CREDIT-DRIVEN ANALYSIS OF ASSET-BACKED SECURITIES

(76) Inventors: MICHAEL A. ERVOLINI, WINTHROP, MA (US); HAROLD J.A. HAIG, BROOKLINE, MA (US); MICHAEL A. MEGLIOLA, BROOKLINE, MA (US)

Correspondence Address: PETER J GORDON, WOLF GREENFIELD & SACKS, 600 ATLANTIC AVENUE, BOSTON, MA, 022102211

(21) Appl. No.: 09/041,500

(22) Filed: Mar. 12, 1998

(51) Int. Cl. G06F 17/60

(52) U.S. Cl. 705/36

(57) ABSTRACT

A computer system or computer-implemented process THAT analyzes pools of loans by considering the combination of interest rates and credit quality which drive asset performance or by incorporating financial reporting. The analysis is called credit-driven because the level of prepayment simulated for each asset in the pool is modulated separately over a projection period based on the projected financial performance of the underlying collateral. Prepayments occur when prepayment is permitted and refinancing results in some specified level of net new proceeds. Similarly, this analysis modulates the level of default simulated for each asset in the pool separately over a projection period. Credit-driven defaults occur when the underlying collateral's net income is insufficient to cover debt service. Following a specified delay, the severity of loss may be computed to reflect the underlying collateral's performance and financeability. Similarly, this analysis modulates the amount of extension simulated for each asset in the pool separately over a projection period. Credit-driven extensions occur when the underlying collateral's income and value are insufficient to support financing of the asset's scheduled balloon payment. Following a specified delay, the balloon repayment is again simulated at which time the asset may experience a balloon shortfall. Such balloon shortfall or calculated severity of loss may be computed to reflect the underlying collateral's performance and financeability.

### COPYRIGHT NOTICE

A portion of the disclosure this patent document, in particular Appendix I, contains material which is subject to copyright protection. The copyright owner has no objection to the facsimile reproduction by anyone of the patent disclosure as it appears in the Patent and Trademark Office patent files or records, but otherwise reserves all copyright rights whatsoever.

### FIELD OF THE INVENTION

The present invention is related to computer systems and computer-implemented processes for analyzing credit risk of pools of assets and bonds and other securities backed by pools of assets.

### BACKGROUND OF THE INVENTION

Analysis of credit risk within pools of assets is a significant part of managing securities backed by those assets. Examples of asset-backed securities are commercial mortgage backed securities (CMBS) and residential mortgage-backed securities (e.g., Ginnie Maes, Fannie Maes). Asset-backed securities typically are constructed with pools of fixed income obligations, such as loans, debentures, notes, commercial paper, etc. One or more bonds are issued, secured by the projected future cash flows from these assets.

For an individual who invests in an asset-backed security, traditional analysis of the credit risk of the assets backing the security includes standard default and prepayment models, such as single monthly mortality (SMM), and constant prepayment rate (CPR) and constant default rate (CDR) analyses, as promulgated by the Bond Market Association (formerly the Public Securities Association). CPR and CDR analyses involve organizing the assets into pools or sub-pools. In general, these analyses assume that the assets in the pool are homogeneous. In other words, each asset is projected to prepay or default at a specified rate and in equal proportions per time period. The CPR analysis involves defining or establishing the percentage of assets that prepay in each projection time period (the CPR “speed”). The CDR analysis involves defining or establishing the percentage of assets that default in each projection time period (the CDR “speed”), the delay (the number of months to resolution), and a fixed amount or level of severity of loss simulated at the resolution of each projected default.

Assuming the assets are loans, each loan in the pool may be acted upon as if it were decomposed into several loans of a fixed, e.g., one dollar ($1.00), size. A proportion of these hypothetical loans is caused to prepay or default. For example, a traditional prepayment analysis might specify that during each period, 1% of the then outstanding loans prepay. A default analysis might specify that 1% of the loans default in each period, and that each defaulted loan bears a certain specified loss “severity,” perhaps 30% of the loan's balance at default. A combined prepay/default analysis applies both behaviors simultaneously. Which loan is assumed to prepay or default is immaterial because all loans within a pool are treated equally.

Sometimes assets that have similar characteristics are grouped, and appropriate “speeds” and “severity” are applied to each groups. For example, loans with high coupon rates might be grouped together and subjected to a higher rate of prepayment, while loans in a given geographic region might be subjected to higher rates of default.

The traditional analysis of asset-backed securities is described in detail, for example, in “Standard Formulas for the Analysis of Mortgage Backed Securities and Other Related Securities,” published Jun. 1, 1990 by the Public Securities Association, which is hereby incorporated by reference. These traditional analytics fail to reflect fully the credit risk of the assets. Fixed income assets exhibit substantial credit risk, including the likelihood that each may prepay or default depending on changes in their credit quality.

Existing analytics focus exclusively on interest rates. These analytics offer no mechanism for directly incorporating, into bond pricing, information regarding current or projected changes in the financial performance of the credits securing the assets. In conventional analysis, the CPR and CDR “speeds,” “delays” and “severity” are assumptions developed exogenously from the application of these analytic techniques.

### SUMMARY OF THE INVENTION

The analysis of pools of assets, such as fixed income obligations, including commercial mortgages, residential mortgages, various loans or debentures, notes, commercial paper, is improved by considering the combination of interest rates and credit quality which drive asset performance or by incorporating financial reporting. The present invention involves a computer system and computer-implemented process for performing such analyses. This kind of analysis is called credit-driven because, for prepayment analysis, the level of prepayment simulated for each asset in the pool is modulated separately over a projection period based on the projected financial performance of the underlying collateral. Prepayments occur when prepayment is permitted under the terms of the asset and refinancing results in some specified level of net new proceeds. Similarly, this analysis modulates the level of default simulated for each asset in the pool separately over a projection period. Credit-driven defaults occur when the underlying collateral's income or cash flow is insufficient to cover debt service. Following a specified delay, the severity of loss may be computed to reflect the underlying collateral's performance and financeability. Extensions also may be determined whenever a balloon shortfall is identified at the maturity date of the asset, also known as the balloon payment date.

Accordingly, in one aspect a computer system and process for credit-driven analysis of a pool of assets modulates a rate of prepayment for each asset separately over a projection period. Assets are considered to prepay when prepayment is permitted under the terms of the asset and refinancing in the projection period results in a prespecified level of net new proceeds.

In another aspect, a computer system and process for credit-driven analysis of a pool of assets modulates a rate of default for each asset separately over a projection period. Assets are considered to default in the projection period when the underlying collateral's income, or cash flow, is insufficient to cover debt service in the projection period.

In another aspect, a computer system and process for credit-driven analysis of a pool of assets identifies loans which default at a specified rate during a projection period. The severity of loss of each defaulted asset is determined according to the underlying collateral's performance and financeability.

In another aspect, a computer system and process for credit-driven analysis of a pool of asset identifies assets which are extended at their maturity date when the balloon balance of the initial asset cannot be refinanced by the collateral, or a balloon shortfall is observed.

### BRIEF DESCRIPTION OF THE DRAWING

In the drawing,

FIG. 1 is a flow chart describing operation of computer system for performing credit driven analysis; and

FIG. 2 is a block diagram of a computer system in one embodiment of the present invention.

### DETAILED DESCRIPTION

The present invention will be more completely understood through the following detailed description which should be read in conjunction with the attached drawing. All references cited herein are hereby expressly incorporated by reference.

In a credit-driven analysis of a pool of assets which back a security, prepayment or default assumptions are applied to each asset individually, depending upon that asset's projected credit quality. Changes in interest rates or credit quality are equally reflected across assets within a given analysis, and likewise are equally reflected from one analysis to the next. In a credit-driven analysis, the rate of prepayment or default in a pool of assets is modulated on an asset-by-asset, period-by-period, e.g., month-by-month, basis. An asset is projected to prepay or default at a specified rate during only those projection periods when that asset meets certain conditions. In particular, credit-driven prepayments occur when (a) prepayment is permitted, for example under terms of a loan, and (b) refinancing results in some specified level of net new proceeds, after paying any required prepayment premium. Credit-driven defaults occur when the underlying collateral's income or cash flow is insufficient to cover debt service. Following a specified delay, the severity of loss is computed to reflect the underlying collateral's performance and financeability. Credit-driven extensions occur at an asset's due date when the financial performance of the collateral securing the asset is inadequate to support refinancing of the balloon balance.

Credit-driven analysis changes the nature of the assertion that underlies a given analysis. For example, a traditional CPR analysis may assert that a certain pool of loans assets will prepay at 5% per year, while a credit-driven analysis might assert that “highly financeable assets will prepay at 25% per year, given a specified yield curve and credit performance assumptions . . . . ” The traditional analysis projects prepayment of all assets in equal proportions; a credit-driven analysis projects prepayment of only those assets of which the collateral is projected to satisfy certain credit requirement. Thus, credit-driven analysis supports investigation of questions like the following: Which assets in a three-year-old pool could be refinanced now at twice their original balance? How are prepayments affected if interest rates fall and credit performance weakens?

Definitions

The following terms are used in this application:

Horizon Yield Curve is a prospective yield curve that represents the assumed yields on various U.S. Treasury obligations. For purposes of creating a cash flow projection, a Horizon Yield Curve or a series of Horizon Yield Curves or a series of specified yield curves is employed in any calculation that depends upon future market interest rates, e.g., a yield maintenance calculation.

Income is the income or cash flow from the collateral securing the asset available for payment of debt service.

Value is the appraised value of the collateral securing the asset.

Growth is an assumed rate (a percentage) by which the income and Value are projected to increase or decrease during the projection period. Growth may vary over the projection period, or from period-to-period. Growth also may be determined by fundamental analysis of the income and expenses associated with the underlying collateral.

Underwriting Standards includes a minimum debt service coverage ratio (DSCR), amortization term, mechanism for establishing coupon rates, and a maximum loan-to-value (LTV) ratio.

Financeable Balance is a prospective estimate of the gross proceeds available through a new debt obligation secured by the collateral. The financeable balance is calculated by projecting t he income and value, applying the underwriting standards by pricing a new debt obligation based on the Horizon Yield Curve, to arrive at projected gross proceeds.

Proceeds to balance (PTB) is a ratio of financeable balance to scheduled outstanding balance.

Net New Proceeds is an excess of the financeable balance minus the sum of the scheduled outstanding balance and any required prepayment premium.

Excess Proceeds is a minimum level of net new proceeds required to cause specified prepayment to occur, at a specified prepayment rate, expressed as a percentage of scheduled outstanding balance.

Debt Service Shortfall is an amount by which a scheduled payment exceeds projected collateral income or cash flow.

Balloon Shortfall is an amount by which the scheduled balance exceeds financeable balance.

Calculated Severity is the sum of the accumulative debt service shortfall over the course of a specified delay and the balloon shortfall at the end of the specified delay.

Description of an Embodiment

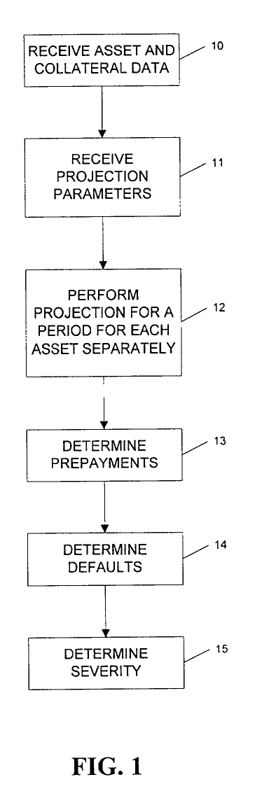

A flow chart describing the operation of a computer system for performing such credit-driven analysis will now be described in connection with FIG. 1. The computer system first receives data describing the asset and the collateral securing the asset for each asset in the pool of assets to be analyzed. This data may be received through a mechanism such as a graphical user interface or data file. For example, where the asset is a loan, this information includes the loan type, the coupon rate, the amortization schedule, the annual principal and interest and loan balance. Other possible loan information may include a scheduled balloon date, scheduled balloon balance, prepayment lock-out provisions, a period during which prepayment is permitted with yield maintenance, and a period within which prepayment is permitted without penalty. The information about the collateral may include its value and its income or cash flow.

The system them receives, in step 11, parameters for the projections to be performed on the pool of assets. This information includes one or more horizon yield curves, and/or actual yield curves, an assumed growth rate, which may vary over the projection period, and underwriting standards. For prepayment analysis, an assumed prepayment rate, and a minimum level for excess proceeds at which level prepayment occurs are established. The excess proceeds level may be defined as a percentage of the balance of the obligation of the asset or as a dollar amount or other value. A default rate and a period of delay are entered to support default projections. These prepayment or default rates may vary over the term of the analysis.

Given the asset data, collateral data, and the projection parameters, projections are then computed for each projection period, e.g., each month, for each asset separately. These projections involve computing a projected financeable balance, proceeds to balance, net new proceeds, excess proceeds, debt service shortfall, and balloon shortfall, as defined above. The computation of these values for each asset may be performed using standard financial techniques.

Next, in step 13, the assets that may prepay are determined by identifying those assets for which a) the terms permit prepayment and b) refinancing results in some specified level of net new proceeds. A specified percentage of these assets, as defined by the prepayment rate, are assumed to prepay. In particular, an asset is projected to prepay at a specified periodic rate only during those periods during which prepayment is permitted and the excess proceeds, as defined above, are equal to or exceed the specified minimum level.

Assets which are projected to default are then determined in step 14 by identifying those assets for which the income or cash flow in the projection period is insufficient to cover the debt service. In other words, an asset may be projected to default only during those periods for which the asset has a debt service shortfall. In each period that an asset experiences a debt service shortfall, defaults occur according to the specified periodic rate. Following a specified delay, the severity of loss is computed in step 15 to reflect the underlying collateral's performance and financeability. The default is subject to a specified delay during which payments may or may not be assumed to be advanced in full, and at the end of which the asset bears a loss equal to the calculated severity as defined above.

Assets which are projected to extend also may be determined by identifying those instances where, at the asset due date, the financial performance of the collateral is insufficient to refinance the balloon balance. In other words, extensions are simulated when balloon deficits are encountered. Upon such extension the due date is extended for a given time period, at the end of which the financial balance is computed and a calculated severity may be projected.

The foregoing steps may be implemented, for example, using a spreadsheet program or a computer programming language. Steps 12 through 15 may be performed for a pool of loans. or for each loan separately. For subsequent projection periods, steps 12 through 15 may be repeated, but excluding any loans that have defaulted or prepaid in a previous projection period.

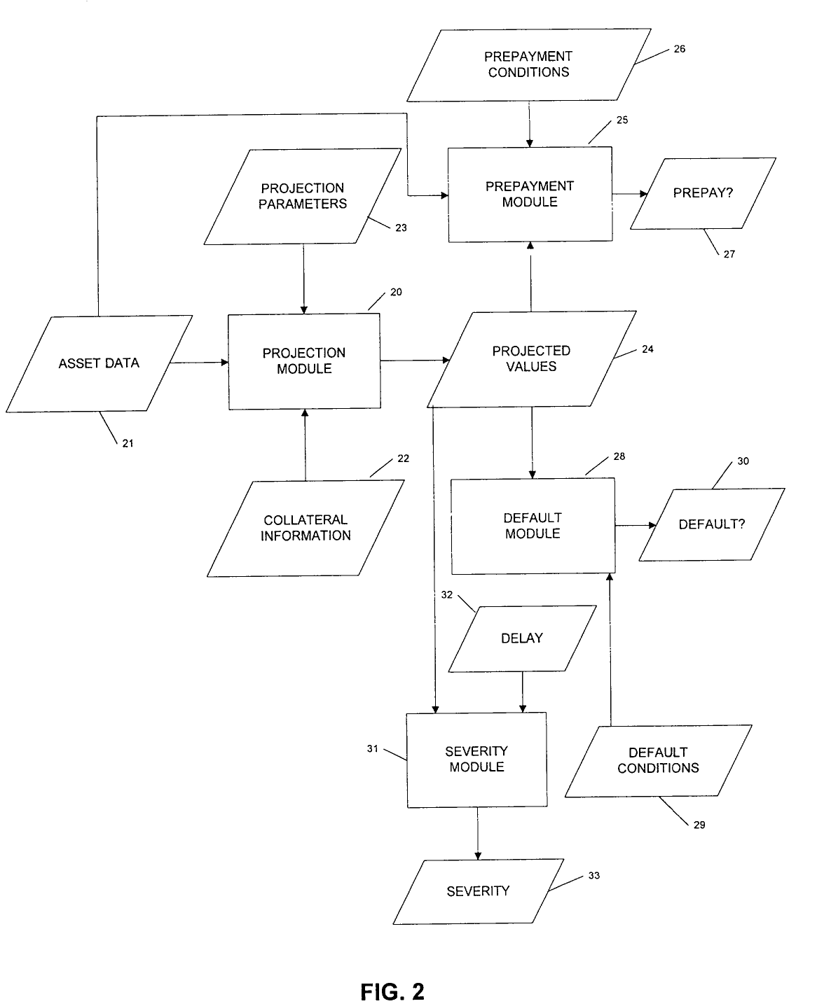

FIG. 2 is a block diagram of a computer system which performs the method of FIG. 1. This system includes a projection module 22 which receives the asset data 21 and collateral information 22, such as in step 10 of FIG. 1. Projection parameters 23 also are received, as indicated in step 11 of FIG. 1. The projection module 20 computes projected values 24, as described above in connection with step 12 of FIG. 1. The prepayment conditions 26, as described as part of the projection parameters in step 11 of FIG. 1, along with the projected values 24 are applied to a prepayment module 25 which evaluates whether the asset should prepay, according to whether the asset 21 permits prepayment and if the excess proceeds exceed the specified minimum level, as in step 13 of FIG. 1. An indication of prepayment is provided at 27. Similarly, a default module 28 receives the projected values 24 and the default conditions 29, received in step 11 of FIG. 1, to determine whether the asset should default, as in step 14 of FIG. 1. An indication of any default is provided as indicated at 30. The projected values 24 also may be used by a severity module 31, in combination with a delay 32, to determine a calculated severity 33, as described in step 15 of FIG. 1.

It should be understood that each module 20, 25, 24 and 31 may be separate modules of a computer program, or may be separate computer programs. Such modules may be operable on separate computers or may be used by separate entities. In one embodiment, the determination of the default and severity may be omitted, allowing for determination only of prepayment. In another embodiment, the determination of prepayment may be omitted, leaving only the determination of the projected defaults. In another embodiment, the default analysis is performed using standard techniques and the calculated severity may be determined for each asset as described herein. In another embodiment, the projected defaults may be determined as described herein, with severity determined using standard techniques. In another embodiment, the projected defaults, severities and prepayments may or may not be calculated by conventional methods or by a credit-driven method, with extensions determined by a balloon shortfall.

Computer program code implementing the steps of FIG. 1 and modules of FIG. 2 in on embodiment is in Appendix I.

A suitable computer system to implement the present invention typically includes a main unit connected to both an output device which displays information to a user and an input device which receives input from a user. The main unit generally includes a processor connected to a memory system via an interconnection mechanism. The input device and output device also are connected to the processor and memory system via the interconnection mechanism.

It should be understood that one or more output devices may be connected to the computer system. Example output devices include a cathode ray tube (CRT) display, liquid crystal displays (LCD), printers, communication devices such as a modem, and audio output. It should also be understood that one or more input devices may be connected to the computer system. Example input devices include a keyboard, keypad, track ball, mouse, pen and tablet. communication device, and data input devices such as sensors. It should be understood the invention is not limited to the particular input or output devices used in combination with the computer system or to those described herein.

The computer system may be a general purpose computer system which is programmable using a computer programming language, such as “C++.” JAVA or other language, such as a scripting language or even assembly language. The computer system may also be specially programmed, special purpose hardware. In a general purpose computer system, the processor is typically a commercially available processor, of which the series x86 and Pentium processors, available from Intel, and similar devices from AMD and Cyrix, the 680×0 series microprocessors available from Motorola, the PowerPC microprocessor from IBM and the Alpha-series processors from Digital Equipment Corporation, are examples. Many other processors are available. Such a microprocessor executes a program called an operating system, of which WindowsNT, UNIX, DOS, VMS and OS8 are examples, which controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory and tape are examples. The disk may be removable, known as a floppy disk, or permanent, known as a hard drive. A disk has a number of tracks in which signals are stored, typically in binary form i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

It should be understood the invention is not limited to a particular computer platform, particular processor, or particular high-level programming language. Additionally, the computer system may be a multiprocessor computer system or may include multiple computers connected over a computer network.

### AN EXAMPLE OF A CREDIT-DRIVEN ANALYSIS

The following example considers the analysis of pools of commercial mortgage loans comprising a commercial mortgage-backed security (CMBS). For this example, the various definitions are modified as follows:

Income is net operating income (NOI) for the property that serves as collateral for a commercial mortgage loan.

Value is appraised property value for the property that serves as collateral for a commercial mortgage loan.

Growth is the assumed rate (a percentage) at which NOI and property value are projected to increase or decrease during the projection period.

The combination of Income, Value, and Growth allow projection of a property's NOI and value during any projection period. Income and Value are collateral credit measures used to compute credit-driven outcomes.

Loan Underwriting Standards are a set of prospective loan-level underwriting standards, including a debt-service coverage ratio (DSCR), amortization schedule, pricing mechanism, e.g., a loan coupon's spread to a specified treasury rate, and maximum loan-to-value ratio (LTV).

Financeable Balance is the prospective estimate of the gross proceeds available through a new loan financing secured by a first mortgage on a given property. Calculating Financeable Balance begins with projected NOI and Property Value, applies Loan Underwriting Standards and arrives at projected gross proceeds.

Net New Proceeds is the excess of the Financeable Balance minus the sum of (i) the scheduled outstanding loan balance and (ii) any required prepayment premium. Net New Proceeds represent the amount of proceeds available to a borrower to cover the costs of a new financing and to retain as proceeds from a new financing. For example, if, in a given projection period, a loan had a scheduled outstanding balance of $6.2 million and required a prepayment premium of $0.4 million, a Financeable Balance of $7.5 million would result in Net New Proceeds of $7.5 million—($6.2 million+$0.4 million)=$0.9 million.

Excess Proceeds is the minimum level of Net New Proceeds required to a cause specified prepayment to occur, at a specified prepayment rate, expressed as a percentage of the scheduled outstanding loan balance. Excess Proceeds indicate that a borrower has an incentive to refinance a property when the level of Net New Proceeds reaches the specified level.

Debt Service Shortfall is the monthly amount by which the scheduled loan payment exceeds projected monthly NOI. Any Debt Service Shortfall causes a specified default to occur, at a specified default rate and delay. For example, a loan with a projected monthly NOI of $200,000 and a scheduled loan payment of $240,000 has a Debt Service Shortfall of $200,000−$240,000=($40,000) per month.

Balloon Shortfall is the amount by which the scheduled loan balance exceeds the Financeable Balance. For example, a loan with a Financeable Balance of $3.8 million and a scheduled balance of $4.2 million has a Balloon Shortfall of $3.8 million—$4.2 million=($0.4 million).

Calculated Severity is the sum of (i) cumulative Debt Service Shortfall over the course of a specified delay and (ii) Balloon Shortfall at the end of the specified delay. For example, a loan that has a cumulative Debt Service Shortfall of $0.5 million over the course of an 18-month delay, and a Balloon Shortfall of $0.9 million at the end of the 18-month delay, has a Calculated Severity of $0.5 million+$0.9 million=$1.4 million.

In this example, assume the CMBS has the following loan in its asset pool:

| | |
|---|---|
| Loan type: | Fixed interest rate, |
| | constant monthly |
| payment, | partially amortizing with |
| | balloon payment |
| Property value: | $5,300,000 |
| Net Operating Income | 400,000 |
| Loan Balance | 4,000,000 |
| Coupon Rate | 8.50% |
| Amortization term | 360 months |
| Annual principal and interest | 352,207 |
| Scheduled balloon date | 10 years |
| Scheduled balloon balance | 3,508,988 |
| Prepayment lock-out | 1-36 months |
| Prepayment permitted with yield maintenance | 37-108 months |
| Prepayment permitted, no penalty | 109-120 months |

A credit-driven analysis enables a determination of how this loan performs if interest rates rise or fall, and if property performance improves or declines. In this example, the projections assume that the Horizon Yield Curve shifts up or down by 200 bp and that Growth equals +2% or −2% per year, respectively. In actuality, the Growth assumption may vary over time, such as “3% for two years, then −15%, then 2% thereafter.” For simplicity, Loan Underwriting Standards are assumed to remain constant at a DSCR of 1.15×, a 360-month amortization term, and a coupon rate of the ten-year treasury plus 170 bp. An actual set of Loan Underwriting Standards may segregate loans by property type, then apply differing standards to each set of loans. The following table summarizes the yield and weighted average life of the loan in this example in several cases.

| | Interest Rates: Up | Interest Rates: Down |
|---|---|---|
| Base case | 8.58%/9.6 yr | 8.58%/9.6 yr |
| Prepayment: Positive growth | 8.62%/9.1 yr | 12.21%/5.0 yr |
| Prepayment: Negative growth | 8.58%/9.6 yr | 8.80%/9.0 yr |
| Default: Positive growth | 8.58%/9.6 yr | 8.58%/9.6 yr |
| Default: Negative growth | 6.77%/7.2 yr | 8.57%/7.2 yr |

Prepayment: Overview

On a loan-by-loan basis, prepayments are projected to occur at a specified periodic rate or speed, but only during those periods that meet two conditions: (i) prepayment is permitted, and (ii) Excess Proceeds equal or exceed a specified percentage of the then scheduled loan balance. Projected prepayments are assumed to adhere to a loan's stated terms. In this example, no prepayment is projected to occur during a loan's lock-out period, and any stated prepayment premium is calculated. For this example, the credit-driven prepayment assumptions are “prepay at 40% CPR when Excess Proceeds are at least 10%.”

Default: Overview

On a loan-by-loan basis, defaults are projected to occur at a specified periodic rate or speed, but only during those periods for which a loan has a Debt Service Shortfall. Any default is subject to a specified delay, e.g., in months, during which loan payments are assumed to be advanced in full, and at the end of which the loan bears loss equal to the Calculated Severity. For this example, the credit-driven default assumptions are “default at 30% with a delay of 12 months.” The default analysis may include possible balloon defaults or loan extensions.

### INTERPRETATION OF CREDIT DRIVEN RESULTS

Prepayment: Interest Rates: Up, Growth: Positive

Following this loan's lock-out period, higher interest rates decrease the Financeable Balance, borrowing new money is more expensive, but also decrease yield maintenance premiums. Positive Growth drives the projected NOI/value and projected property value upward, increasing the Financeable Balance. Net New Proceeds are effectively driven in two directions—downward, because of the increased cost of new financing, and upward, because of a diminished yield maintenance premium and to an increasing projected NOI/value. If Growth is sufficient to overwhelm increased financing costs, prepayments occur.

Prepayment: Interest Rates: Up, Growth: Negative

Following this loan's lock-out period, higher interest rates decrease the Financeable Balance, borrowing new money is more expensive, but also decrease yield maintenance premiums. Negative Growth drives projected NOI/value and projected property value downward, decreasing the Financeable Balance. Net New Proceeds are effectively driven downward—because of both the increased cost of new financing and the decreasing projected NOI/value. The offsetting effect of decreasing prepayment premiums is unlikely to ever trigger a prepayment. Prepayments do not occur.

Prepayment: Interest Rates: Down, Growth: Positive

Following this loan's lock-out period, Lower interest rates increase the Financeable Balance, borrowing new money is cheaper, but also increase yield maintenance premiums. These effects may roughly offset each other, depending upon the remaining life of the loan and the slope of the Horizon Yield Curve. Yield maintenance premiums diminish as remaining life diminishes, but are typically computed using a shortening-maturity treasury rate, which increases premium with a positively-sloped yield curve. Positive Growth drives the projected NOI/value and projected property value upward, increasing the Financeable Balance. Net New Proceeds are effectively driven upward—because of both the decreased cost of new financing and increasing projected NOI/value. The offsetting effect of increasing prepayment premiums is unlikely to prevent a prepayment. When cumulative Growth, with lower interest rates. is sufficient to drive Net New Proceeds to a specified level, prepayments occur. The yield maintenance premium dampens but does not prevent prepayment.

Prepayment: Interest Rates: Down, Growth: Negative

Following this loan's lock-out period, lower interest rates increase the Financeable Balance, borrowing new money is cheaper, but also increase yield maintenance premiums. These effects may roughly offset each other, depending upon the remaining life of the loan and the slope of the Horizon Yield Curve. Yield maintenance premiums diminish as remaining life diminishes, but are typically computed using a shortening-maturity treasury rate, which increases premium with a positively-sloped yield curve. Negative Growth drives the projected NOI/value and projected property value downward, decreasing the Financeable Balance. Net New Proceeds are effectively driven in two directions—upward, because of the decreased cost of new financing, and downward, because of an increased yield maintenance premium and to a decreasing projected NOI/value. The combined dampening effect of lower NOI/value plus an increased yield maintenance premium likely overwhelm the benefit of decreased borrowing costs. Accordingly, prepayments are prevented or substantially curtailed.

Default: Interest Rates: Up, Growth: Positive

Starting at the outset of the projection, for fixed-payment loans, higher interest rates do not affect the incidence of default because Debt Service Shortfall is independent of interest rates. Higher interest rates decrease the Financeable Balance, increasing Balloon Shortfall, and therefore increasing Calculated Severity. For adjustable-rate/adjustable payment loans, higher interest rates would affect Debt Service Shortfall. Positive Growth drives projected NOI upward guaranteeing no Debt Service Shortfall. Because NOI is always sufficient to cover scheduled loan payments, no defaults occur.

Default: Interest Rates: Up, Growth: Negative

Starting at the outset of the projection, for fixed-payment loans, higher interest rates do not affect the incidence of default because Debt Service Shortfall is independent of interest rates. Higher interest rates decrease the Financeable Balance, increasing Balloon Shortfall, and therefore increasing Calculated Severity. For adjustable-rate/adjustable payment loans, higher interest rates would affect Debt Service Shortfall. Negative Growth drives projected NOI downward, eventually causing Debt Service Shortfall and triggering defaults. Diminishing NOI increases Calculated Severity, both by increasing cumulative Debt Service Shortfall over the course of a specified delay and by decreasing Financeable Balance. Diminishing NOI causes defaults to occur and diminishing NOI and higher interest rates each increase Calculated Severity. Accordingly, defaults occur and losses are severe.

Default: Interest Rates: Down, Growth: Positive

Starting at the outset of the projection, for fixed-payment loans, lower interest rates do not affect the incidence of default because Debt Service Shortfall is independent of interest rates. Lower interest rates increase the Financeable Balance, decreasing Balloon Shortfall, and therefore decreasing Calculated Severity. For adjustable-rate/adjustable payment loans, lower interest rates would affect Debt Service Shortfall. Positive Growth drives projected NOI upward, guaranteeing no Debt Service Shortfall. Because NOI is always sufficient to cover scheduled loan payments, no defaults occur.

Default: Interest Rates: Down, Growth: Negative

Starting at the outset of the projection, for fixed-payment loans, lower interest rates do not affect the incidence of default because Debt Service Shortfall is independent of interest rates. Lower interest rates increase the Financeable Balance, decreasing Balloon Shortfall, and therefore decreasing Calculated Severity. For adjustable-rate/adjustable payment loans, lower interest rates would affect Debt Service Shortfall. Negative Growth drives projected NOI downward, eventually causing Debt Service Shortfall and triggering defaults. Diminishing NOI also contributes to Calculated Severity, in the form of cumulative Debt Service Shortfall over the course of a specified delay. Diminishing NOI causes defaults to occur and diminishing increases Calculated Severity but cheaper borrowing reduces Calculated Severity. Accordingly, defaults occur, losses are mitigated by lower interest rates.

### IMPLICATIONS OF CREDIT DRIVEN ANALYSIS

There are several advantages of using credit-driven analyses.

Credit-driven analyses fully reflect changes in interest rates—whether through an asset's stated terms, e.g., terms OF an adjustable-rate loan, or by modeling rational borrower behavior, e.g., the decreasing likelihood of satisfying a balloon repayment as interest rates rise and financing proceeds decline. Credit-driven analysis offers the underpinning for option-adjusted spreads analysis, for example of bonds backed by pools of auto loans, air craft leases, single family house loans, etc.

Credit-driven analysis offers a way to incorporate fundamental market research on collateral into pricing of securities. The future growth in collateral income and value is a key independent variable that determines credit-driven results. Credit driven analysis directly incorporates reported collateral-level financial information, and therefore depends upon accurate and timely reporting of collateral operating results. Credit-driven analysis may compel investors to demand more and better reporting on the collateral.

Credit-driven analysis allows investors to differentiate risks more clearly within transactions. Differences in the character of a given asset pool, e.g., coupon rates, loan terms, performance of underlying collateral, are immediately expressed as differences in bond prices. As transactions age, these differences may become more distinct. If broadly employed, credit-driven analysis may cause greater price differentiation among asset-backed securities.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention as defined by the appended claims and equivalents thereto.

What is claimed is:

1. A computer system for credit-driven analysis of a pool of assets, comprising:
means for modulating a rate of prepayment for each asset separately over a projection period; and
means for identifying assets which prepay in the projection period when prepayment is permitted in the projection period and refinancing in the projection period results in a prespecified level of net new proceeds.

2. A computer system for a credit-driven analysis of a pool of assets, comprising:
means for modulating a rate of default for each asset separately over a projection period; and
means for identifying assets which default in the projection period when the income from the collateral available for debt service payment is insufficient to cover debt service in the projection period.

3. A computer system for credit-driven analysis of a pool of assets, comprising:
means for identifying assets which default at a specified rate during a projection period; and
means for determining the severity of loss of each defaulted asset according to the underlying collateral's performance and financeability.

4. A computer system for credit-driven analysis of a pool of assets, comprising:
means for identifying whether an asset may have an extension when a balloon shortfall is projected to occur on the balloon payment date; and
means for calculating a resolution of the extension after a predetermined delay.

5. The computer system of claim 4, further comprising means for calculating a severity of loss after the predetermined delay.

6. A computer system for credit-driven analysis of a pool of assets, comprising:
means for receiving information describing the asset and the collateral securing the asset and projection parameters specifying a growth rate for collateral, income and value for each asset; and
means for projecting over a projection period, each asset separately, in each projection period, the value and income of the collateral securing each asset.
